(19) United States
(12) Patent Application Publication
(10) Pub. No.: US 2019/0003226 A1
(43) Pub. Date: Jan. 3, 2019

(54) Oiling System For Hinges

(71) Applicant: Abdullah S. Alghamdi, Newark, DE (US)

(72) Inventor: Abdullah S. Alghamdi, Newark, DE (US)

(21) Appl. No.: 16/124,299

(22) Filed: Sep. 7, 2018

Related U.S. Application Data
(63) Continuation-in-part of application No. 14/676,805, filed on Apr. 1, 2015, now abandoned.

(51) Int. Cl. E05D 11/02; F16N 7/02; F16N 39/00

(52) U.S. Cl. CPC E05D 11/02; F16N 7/02; E05Y 2800/108; F16N 2210/00; F16N 39/00

(57) ABSTRACT

Oil System for Hinges is a mechanism that provides door hinges with a controlled consistent oiling to prevent the problems related to the lack of lubrication or/and for the sake of scenting. It is mainly a small article placed on the top of the hinge pin cap. It is provided with a lubricant chamber and a lubricant flow-controlling mechanism. The means of controlling the lubricant flow can be passive, active or indirect.

### CROSS-REFERENCE TO RELATED APPLICATIONS

This patent application is a continuation-in-part of an earlier filed application with the following information:

Title: “Oiling System for Door Hinges”

Inventor: Abdullah Alghamdi (the current applicant)

Application Ser. No. 14/676,805

Filing Date: Apr. 1, 2015

### BACKGROUND OF THE INVENTION

The invention aims to solve the problems resulting from the friction between the parts of door hinges, especially the problem of noisy sounds when opening or closing the doors. A main function of the invention is to supplying door hinges with a controlled consistent oiling mechanism that insures sooth friction between its parts. The invention is an article placed on the top of the door hinge and comprises a lubricant chamber and a controlling mechanism. The idea of placing/allocating a lubricant chamber on the top the hinge is found in the prior-art (e.g. McKinney Jr.; U.S. Pat. No. I800,311). However, earlier inventions do not comprise a dedicated flow-controlling mechanisms. Moreover, those inventions have been silent regarding controlling the flow of lubricants.

### BRIEF SUMMARY OF THE INVENTION

The invention consists of a lubricant chamber, a controlling mechanism and a holder. The controlling mechanism provides one or a combination of the following options:

(i) Passive control where the flow of the lubricant is set to a certain fixed rate during manufacturing process.

(ii) Active control where the invention user can control the flow of the lubricant from zero to the desired rate.

(iii) On-demand control where the invention user releases the lubricant as needed.

(ix) Redirecting the released lubricant away from the hinge. This is utilized, for example, in cases if a scented oil is used where the lubricant can be redirected to a diffuser.

(x) Indirect control where the release of the lubricant is triggered by the door movement.

### BRIEF DESCRIPTION OF THE SEVERAL VIEWS OF THE DRAWING

FIG. 1: shows the invention with passive control mechanism.

FIGS. 2 & 3: show how it is attached.

FIG. 4: shows an on-demand embodiment.

FIG. 5: shows lubricant redirection.

FIG. 6: shows gradual lubrication.

FIG. 7: shows indirect lubrication.

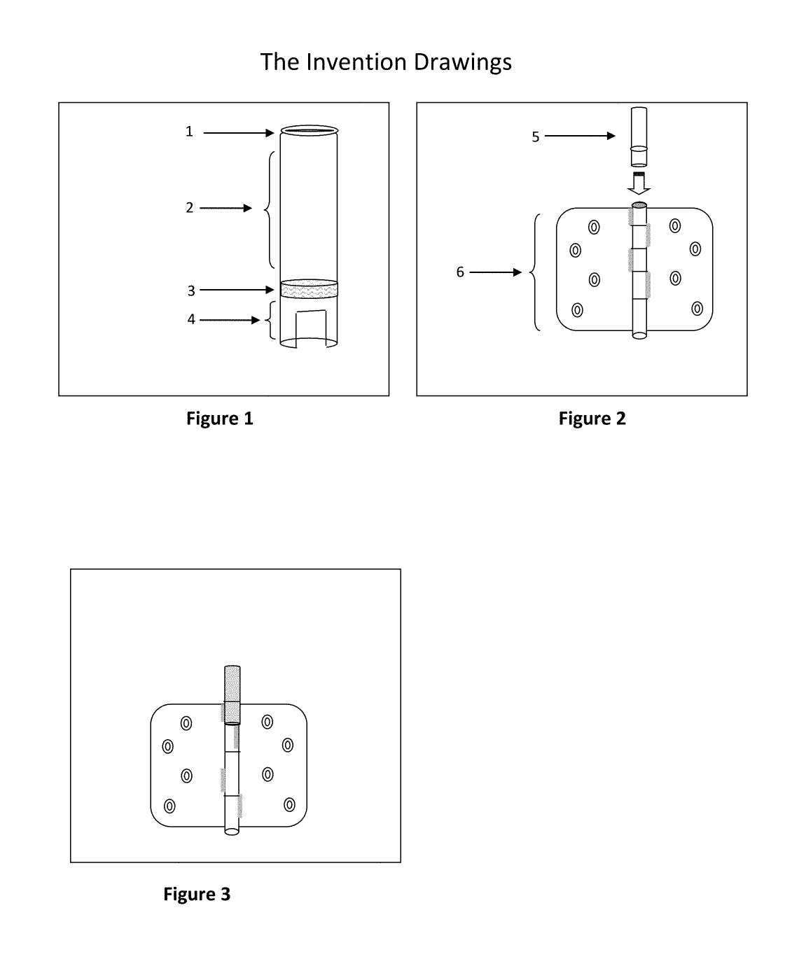

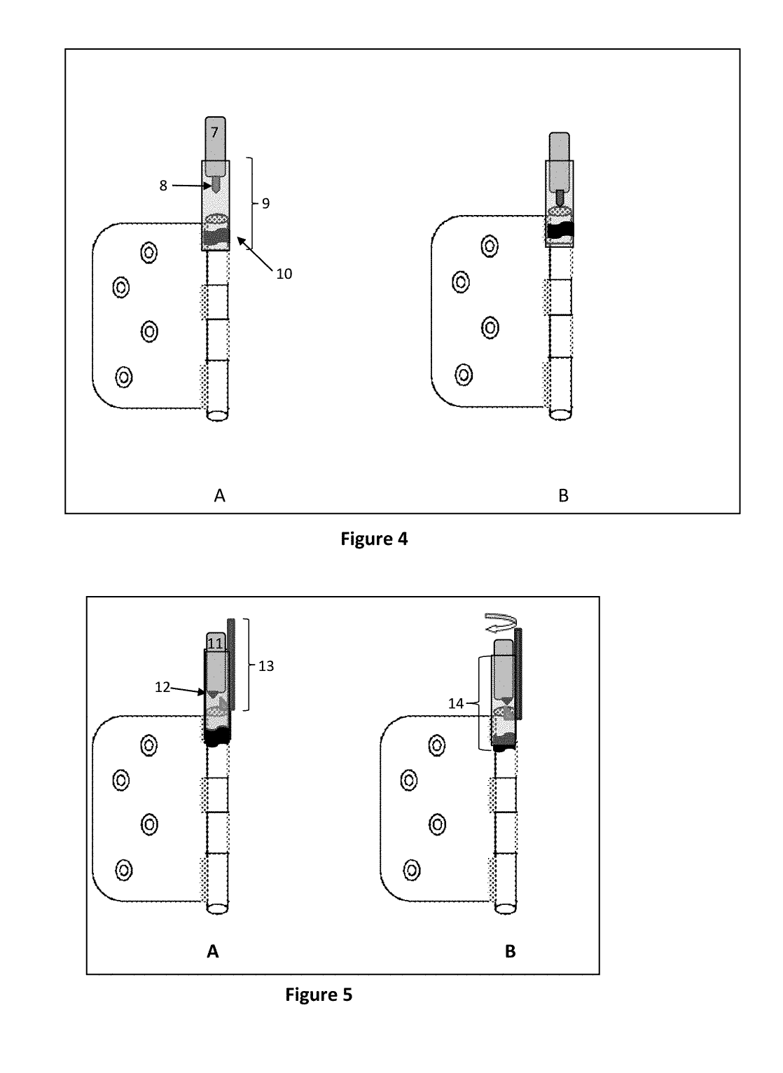

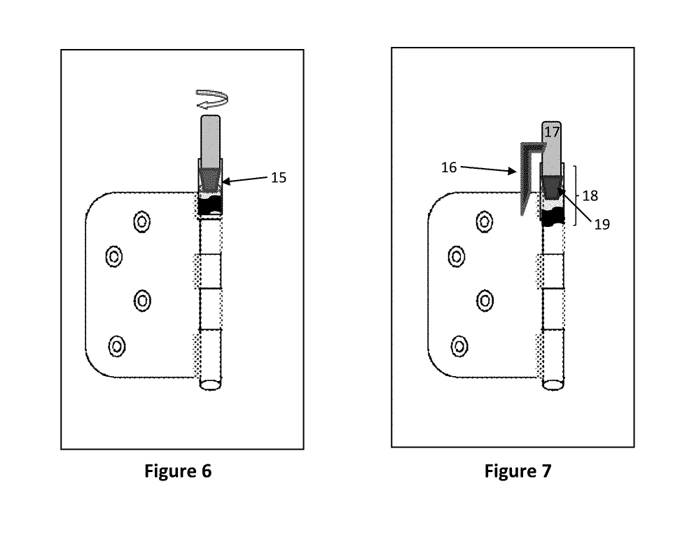

### DETAILED DESCRIPTION OF THE INVENTION

The invention has many embodiments, I will describe here the most relevant. In all embodiments the invention contains a lubricant chamber, a flow-controlling mechanism and a holder.

FIG. (1) shows an over view of the invention with a passive controlling mechanism. The invention parts are: a chamber ceiling (No.1) that can either be sealed or left open, a lubricant chamber (No. 2), a controlling part (No. 3) and a holder (No.4). The controlling part here is a filter (No. 3). The flow of lubricant is set to the desired rate at the time of manufacturing not by the user, hence, it is passive. The rate of the flow is achieved by choosing a filter with the relevant permeability. The holder (No. 4) is simply a clip attached to the chamber. FIG. (2) shows how invention is fixed to the hinge and FIG. (3) shows the hinge after attachment. The passive lubrication is realized with an oil-absorbent material filling, at least partially, the lubricant chamber.

Another version of the invention allows the user to release the lubricant on-demand. FIG. (4) shows an embodiment of this type. In this embodiment, the diffuser (8) has the ability to absorb the lubricant, but it will not release the lubricant to the hinge unless it has a direct contact with, at least, one part of the hinge (the same principle as in color markers; they don't release colors until directly touch a surface). The rate of lubricant flow depends on how much of the diffuser is in direct contact with the hinge. FIG. (3) shows that the lubricant chamber (No. 7) can move inside the holder (No.9). Consequently, the lubricant chamber would have, at least, two positions. No. (10) is a clip for the holder fixation. Any means of lubricant release can be utilized for this type of the invention including air displacement by, for example, pressing the sides of the lubricant chamber.

FIG. (5) shows the controlling mechanism for redirecting the released lubricant. The flow controller (No.12) is aligned to one side of the lubricant chamber (No. 11) which has the ability to rotate within the holder (No. 14). In position (A), the lubricant is directly released to the hinge. In position (B), the lubricant is released directly released on a diffuser (No. 13) specially if the lubricant is mix with other materials such as scents.

FIG. (6) shows the invention with a gradual lubrication mechanism. A valve (No. 15) is responding to the rotation of the lubricant chamber by decreasing or increasing the rate of flow. The lowest rate for this embodiment can be zero.

The last embodiment I describe is the invention with indirect control of lubrication. FIG. (7) shows that the lubricant chamber (No. 17) is attached to one of the hinge leaves with a lever (No. 16) while the holder (No. 18) is attached to the other leaf. The hinge will trigger the valve (No. 19) as the door opens or closes.

All embodiments have the option to be filled with lubricants and sealed during the process of manufacturing. Moreover, All parts of the invention can be separately or jointly replaced. The lubricant can be scented or mixed with other materials.

What is claimed is:

1- An article which is placed on a top of a hinge and comprises: a lubricant chamber, a controlling mechanism to control the flow of the lubricant and a holder.

2- The lubricant chamber in claim (1) is sealed and prefilled with a lubricant.

3- The controlling mechanism in claim (1) allows a fixed lubricant flow rate.

4- The controlling mechanism in claim (1) allows a gradual lubricant flow rate.

5- The holder in claim (1) is, at least partially, made of a lubricant diffusing material.

6- The controlling mechanism in claim (1) redirects the lubricant flow away from the hinge.

7- The article in claim (1) comprises a sequence of, at least, two horizontally-aligned sets of lubricant chambers and controlling mechanisms wherein a higher set discharges a lubricant to a lower set.

8- The sets in claim (7) are parallel-aligned where each lubricant chamber discharges a lubricant directly to the hinge.

9- The article in claim (1) is disposable.

10- The article in claim (1) constitutes a removable decorative upper hinge tip.

11- The article in claim (1) contains, at least, one logo.

12- The lubricant chamber in claim (1) is, at least partially, filled with an oil-absorbent material.

13- The lubricant in claim (1) is scented.

14- The components of the article in (1) have an ability to be separately replaced.

15- The components of the article in (1) have an ability to be jointly replaced.
